(19) United States
(12) Patent Application Publication
(10) Pub. No.: US 2016/0243766 A1
(43) Pub. Date: Aug. 25, 2016

(54) Energy Star for Manufacturing

(71) Applicant: Siemens Aktiengesellschaft, Munich (DE)

(72) Inventors: Erhan Arisoy, Pittsburgh, PA (US); Suraj Ravi Musuvathy, Glenmont, NY (US); Lucia Mirabella, Plainsboro, NJ (US); Sanjeev Srivastava, Princeton, NJ (US); Livio Dalloro, Princeton, NJ (US); Noorie Rajvanshi, Lawrenceville, NJ (US)

(21) Appl. No.: 15/051,743

(22) Filed: Feb. 24, 2016

Related U.S. Application Data
(60) Provisional application No. 62/119,991, filed on Feb. 24, 2015.

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

A computer-implemented method for optimizing manufacturing of a product based on total life cycle energy consumption includes receiving manufacturing parameters associated with manufacturing the product according to a manufacturing process and a candidate hybrid manufacturing plan for implementing the manufacturing process using a first combination of additive manufacture techniques and non-additive manufacture techniques. An energy consumption dataset is generated comprising (i) first energy consumption data corresponding to a non-additive manufacturing process, (ii) second energy consumption data corresponding to an additive manufacturing process, and (iii) energy intensity data associated with manufacturing materials. Next, the total life-cycle energy consumption for the candidate hybrid manufacturing plan is computed. Then, the manufacturing process is optimized according to the manufacturing parameters and the energy consumption dataset to identify alternative hybrid manufacturing plans which result in lower total life-cycle energy consumption in comparison to the total life-cycle energy consumption associated with the candidate hybrid manufacture plan.

### CROSS-REFERENCE TO RELATED APPLICATIONS

This application claims the benefit of U.S. Provisional Application Ser. No. 62/119,991 filed Feb. 24, 2015, which is incorporated herein by reference in its entirety.

### TECHNICAL FIELD

The present disclosure generally relates to systems, methods, and apparatuses for combining additive manufacturing and conventional manufacturing techniques in a manner that optimizes lifecycle energy usage during the overall manufacturing process.

### BACKGROUND

As additive manufacturing (AM) machines that are capable of processing different materials such as metals and composites become widely available for large-scale manufacturing, there is a growing need for computer-aided manufacturing technology that can combine additive with conventional manufacturing (CM) for energy efficient, high yield and low cost manufacturing solutions. This alliance between AM and CM, called hybrid manufacturing (HM), aims to bring best features of both approaches such as high performance complex parts (produced by AM) in bulk volumes (produced by CM).

The relationship between AM and CM technologies can be viewed as a series of tradeoffs based upon which technology is more suitable for target manufacturing application. However, finding the sweet spot that balances both approaches for an energy efficient manufacturing plan is a challenging task for humans where they rely on their innate abilities using existing computer-aided manufacturing (CAM) and process planning (CAPP) tools. In addition, each stage of a product life cycle chain may contribute to energy consumption. This contribution needs to be taken into account to determine the peak point of energy consumption and optimize the overall energy footprint. If this challenge can be alleviated, the selected manufacturing plans will require less energy overall and therefore results in less grid power, less carbon based fossil energy resources, reduced energy dependence and lower emissions.

### SUMMARY

Embodiments of the present invention address and overcome one or more of the above shortcomings and drawbacks, by providing methods, systems, and apparatuses related to combining additive manufacturing and conventional manufacturing techniques in a manner that optimizes energy usage during the overall manufacturing process. For example, the present application describes a decision support system for designers and engineers used in some embodiments that takes as input a user-selected manufacturing plan comprising both additive and conventional techniques and calculates total energy used over the total lifetime of the input product. This technology will help designers and engineers to optimize manufacturing plans on their own by providing recommendation of alternative processes that result in less total energy, therefore increasing overall energy efficiency of product design, modeling and manufacturing framework.

According to some embodiments, a computer-implemented method for optimizing manufacturing of a product based on total life cycle energy consumption includes receiving manufacturing parameters associated with manufacturing the product according to a manufacturing process (e.g., raw materials used, number of products to be manufactured, transportation requirements, etc.). The computer also receives a candidate hybrid manufacturing plan for implementing the manufacturing process using a first combination of additive manufacture techniques and non-additive manufacture techniques. An energy consumption dataset is generated comprising (i) first energy consumption data corresponding to a non-additive manufacturing process, (ii) second energy consumption data corresponding to an additive manufacturing process, and (iii) energy intensity data associated with manufacturing materials. Next, the total life-cycle energy consumption for the candidate hybrid manufacturing plan is computed. Then, the manufacturing process is optimized according to the manufacturing parameters and the energy consumption dataset to identify alternative hybrid manufacturing plans which result in lower total life-cycle energy consumption in comparison to the total life-cycle energy consumption associated with the candidate hybrid manufacture plan.

Various techniques may be used for optimizing the manufacturing process according to different embodiments of the aforementioned method. For example, in some embodiments, the manufacturing process is optimized by analyzing a CAD model of the product to identify alternate product geometries which reduce the total life-cycle energy consumption in comparison to the total life-cycle energy consumption associated with the candidate hybrid manufacture plan. At least one of the alternative hybrid manufacturing plans may then correspond to one of the alternate product geometries. In some embodiments, an evidence theory-based uncertainty propagation technique is used during optimization of the manufacturing process to identify the one or more alternative hybrid manufacturing plans.

In some embodiments of the aforementioned method, a dimensionality reduction process is applied to the manufacturing parameters to disregard one or more of the manufacturing parameters prior to optimizing the manufacturing process. For example, in one embodiment, the manufacturing parameters comprise baseline parameters and a probability for each of the baseline parameters. The dimensionality reduction process may then include receiving one or more performance requirements and for each respective baseline parameter included in the baseline parameters, using the computer to perform an analysis process. This analysis process would include selecting a range of parameter values for the respective baseline parameter based on its corresponding probability distribution, segmenting the range of parameter values into parameter subsets based a pre-determined granularity for the respective parameter, and running instances of a simulation using the one or more performance requirements to yield snapshots, wherein each respective instance corresponds to one of the parameter subsets. Using the snapshots, a reduced order model may be derived and a sensitivity analysis may be performed based on the reduced order model (e.g., a Proper Orthogonal Decomposition (POD) basis) to yield a sensitivity measurement representative of an effect of variation of the respective parameter on the one or more performance requirements. The baseline parameters may next be ranked according to their corresponding sensitivity measurements. Then, a predetermined number of lowest ranking baseline parameters may be removed from the manufacturing parameters.

According to other embodiments, a second computer-implemented method for optimizing manufacturing of a product based on total life cycle energy consumption includes a computer receiving a manufacturing process comprising a plurality of steps and generating an energy consumption dataset comprising (i) first energy consumption data corresponding to a non-additive manufacturing process, (ii) second energy consumption data corresponding to an additive manufacturing process, and (iii) energy intensity data associated with a plurality of manufacturing materials. The computer uses the energy consumption dataset to identify an optimal hybrid manufacturing plan which implements the plurality of steps using a combination of additive manufacture techniques and non-additive manufacture techniques and minimizes total product life-cycle energy consumption. In some embodiments, prior to identifying the optimal hybrid manufacturing plan, a dimensionality reduction process is applied to the energy consumption dataset to disregard energy consumption data items having minimal impact to the total product life-cycle energy consumption.

The total product life-cycle energy consumption produced by the aforementioned second computer-implemented method may comprise for example, a summation of energy consumption measures comprising (i) a measure of manufacturing energy consumption (ii) a measure of freight and distribution energy consumption, (iii) a measure of energy consumption during use-phase of the product, and (iv) a measure of end of life energy consumption. The method may further include providing a visual representation of each of the energy consumption measures in a graphical user interface for display to a user.

The features of the aforementioned second computer-implemented method for optimizing manufacturing of a product may be modified in different embodiments. For example, in one embodiment, the energy consumption dataset is used to identify one or more alternative hybrid manufacturing plans which implement the manufacturing process using an alternative combination of additive manufacture techniques and non-additive manufacture techniques. A graphical user interface may then be used to present differences between the total product life-cycle energy consumption associated with the optimal hybrid manufacturing plan and the alternative total product life-cycle energy consumption in a graphical user interface for display to a user. In some embodiments, uncertainty quantification measurements associated with the optimal and hybrid plan are determined and also presented in the graphical user interface.

According to other embodiments, a system for optimizing manufacturing of a product based on the product's total life cycle energy consumption comprises a user interface, non-volatile memory, and a computer. The user interface is configured to receive (i) an indication of the product, (ii) a plurality of manufacturing parameters associated with manufacturing the product according to a manufacturing process, and (iii) a candidate hybrid manufacturing plan for implementing the manufacturing process using a first combination of additive manufacture techniques and non-additive manufacture techniques. The non-volatile memory includes a database storing (i) first energy consumption data corresponding to non-additive manufacturing processes, (ii) second energy consumption data corresponding to additive manufacturing processes, and (iii) energy intensity data associated with a plurality of manufacturing materials. The computer is configured to compute total life-cycle energy consumption associated with the product when manufactured according to the candidate hybrid manufacturing plan; and optimize the manufacturing process according to the manufacturing parameters and data in the database to identify one or more alternative hybrid manufacturing plans which result in lower total life-cycle energy consumption in comparison to the total life-cycle energy consumption associated with the candidate hybrid manufacture plan. Each alternative hybrid manufacturing plan uses a distinct alternative combination of additive manufacture techniques and non-additive manufacture techniques. In some embodiments, the system additionally includes a manufacturer interface which is configured to: (i) use one or more application program interfaces energy consumption data to receive from one or more manufacturing materials producers; (ii) structure the energy consumption data in a standard data format; and (iii) store the energy consumption data the database.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides a diagram of a system for combining additive manufacturing and conventional manufacturing techniques in a manner that optimizes energy usage during the overall manufacturing process, according to some embodiments;

FIG. 2 provides an flow chart illustrating a computer-implemented method for optimizing a manufacturing plan for a product based on total life cycle energy consumption, according to some embodiments; and

FIG. 3 illustrates an exemplary computing environment within which embodiments of the invention may be implemented.

### DETAILED DESCRIPTION

The following disclosure describes the present invention according to several embodiments directed at methods, systems, and apparatuses related to combining additive manufacturing and conventional manufacturing techniques in a manner that optimizes energy usage during the overall manufacturing process. Briefly, the techniques described herein include a decision support system for designers and engineers that analyze an input CAD model or assembly of a real product to identify a hybrid manufacturing process comprising both additive manufacturing and conventional manufacturing that minimizes energy used over the life time of the input product. The techniques described herein may be used, for example, to reduce imported energy, reducing energy-related emissions, and improving energy efficiency.

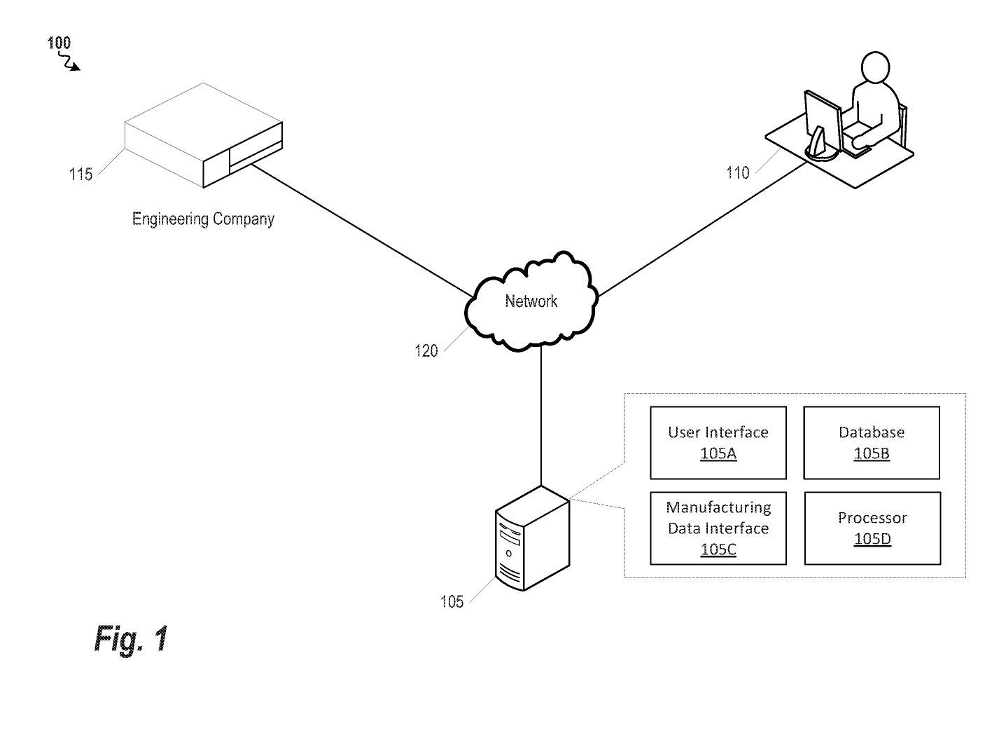

FIG. 1 provides a diagram of a system 100 for combining additive manufacturing and conventional manufacturing techniques in a manner that optimizes energy usage during the overall manufacturing process, according to some embodiments. At the heart of the system 100, is a Life Cycle Energy Assessment (LCEA) Computer 105 which is configured to calculate the total amount of energy embodied over a product's entire life cycle. The LCEA Computer 105 is connected to one or more external data sources (e.g., Engineering Company 115) via a Network 120 such as the Internet. Additionally, over the same Network 120, an outside User 110 can provide input to the LCEA Computer 105 and review output data. It should be noted that this configuration is an example provided for illustration purposes and different configurations may be used in different embodiments. For example, in some embodiments, the functionality provided by the LCEA Computer 105 (described in further detail below) is provided in an LCEA software tool residing on the computer of User 110.

The LCEA Computer 105 incorporates information such as, for example, material, manufacturing, freight and distribution, use-phase energy, and end-of-life (disposal or reuse or recycling) energy to identify a hybrid manufacturing process that combines additive and conventional manufacturing techniques. This LCEA Computer 105 comprises a User Interface 105A, a Database 105B, a Manufacturing Data Interface 105C, and Processor 105D. Each of these components is described in further detail below.

The User Interface 105A comprises software and hardware operable to communicate with a User 110 and receive input data for performing the energy consumption analysis. This input data may include, for example, an indication of the product, manufacturing parameters associated with manufacturing the product according to a manufacturing process, and a candidate hybrid manufacturing plan for implementing the manufacturing process using a combination of additive and non-additive manufacturing techniques.

Database 105B is stored within non-volatile memory of the LCEA Computer 105. This Database 105B includes energy consumption data for a variety of different products and manufacturing techniques. Thus, Database 105B may include information such as energy consumption data corresponding to non-additive manufacturing processes, consumption data corresponding to additive manufacturing processes, and energy intensity data associated with various manufacturing materials.

The Database 105B is populated by a Manufacturing Data Interface 105C which uses one or more application program interfaces to receive energy consumption data from manufacturing materials producers or process designers such as Engineering Company 115. In some embodiments, a “push” architecture is employed wherein producers and designers may upload relevant data to the Database 105B. In other embodiments, a “pull” architecture is used where data is retrieved by the LCEA Computer 105 from one or more external systems. Prior to storage in the Database 105B, the Manufacturing Data Interface 105C may reformat the received energy consumption data such that it is structured in a standard data interchange format (e.g., JavaScript Object Notation, Extensible Markup Language, etc.). By storing data in a single format, the software associated with later reading of the data may be simplified by eliminating the need for a variety of data conversions to be performed at runtime.

In some embodiments, rather than directly receiving energy consumption data from the manufacturing materials producers or process designers, the data received from these entities is limited to engineering specifications. These specifications may then be used to derive the energy consumption data using any technique known in the art. For example, in one embodiment, the Manufacturing Data Interface 105C has access to energy consumption data associated with a variety of generic process steps and/or materials. By matching details included in the engineering specifications to the generic information, energy consumption data for the engineering specification may be determined.

Processor 105D computes the total life-cycle energy consumption associated with the product when manufactured according to the candidate hybrid manufacturing plan. Using this candidate manufacturing plan as a comparison, the Processor 105D optimizes the manufacturing process over each manufacturing step according to the manufacturing parameters and data in the Database 105B to identify one or more alternative hybrid manufacturing plans which result in lower total life-cycle energy consumption in comparison to the candidate hybrid manufacture plan. Each alternative hybrid manufacturing plan uses a distinct alternative combination of additive manufacture techniques and non-additive manufacture techniques. The optimization performed by the Processor 105D may be implemented using any technique generally known in the art. For example, in some embodiments, the optimization is implemented as an integer programming problem in which all of the variables are restricted to be integers with linear objective function and constraints. In order to solve this optimization problem, the user can utilize any of the relevant optimization algorithms tailored toward scheduling and assignment problems. These techniques include both exact algorithms (Branch and Bound, cutting planes) and heuristic methods (hill climbing, simulated annealing, ant colony optimization). In some embodiments, evidence-theory or similar techniques may be used to quantify the uncertainty associated with each alternative hybrid manufacturing plan. Thus, one may identify the risks associated with implementing each alternative plan.

In some embodiments, the Processor 105D is configured to use techniques which may automatically rank design manufacturing parameters using parameter sensitivity feedback. Using this information, parameters which have less impact on energy consumption may be eliminated from the optimization operations required to select the alternative manufacturing plans. For example, in some embodiments, model reduction techniques are used to analyze high-dimensional dynamical systems using lower-dimensional approximations, which reproduce the characteristic dynamics of the system. Using these approximations, an understanding of the effects of different parameters on design requirements can be developed while minimizing computational cost and storage requirements. Parameters may then be ranked as highly significant if a metric (or combination of metrics) of interest is highly sensitive to that parameter. Example techniques for ranking design parameters are described in U.S. patent application Ser. No. 14/957755, entitled “Automatic Ranking of Design Parameter Significance for Fast and Accurate CAE-Based Design Space Exploration Using Parameter Sensitivity Feedback,” filed Dec. 3, 2015 and are hereby incorporated by reference in its entirety.

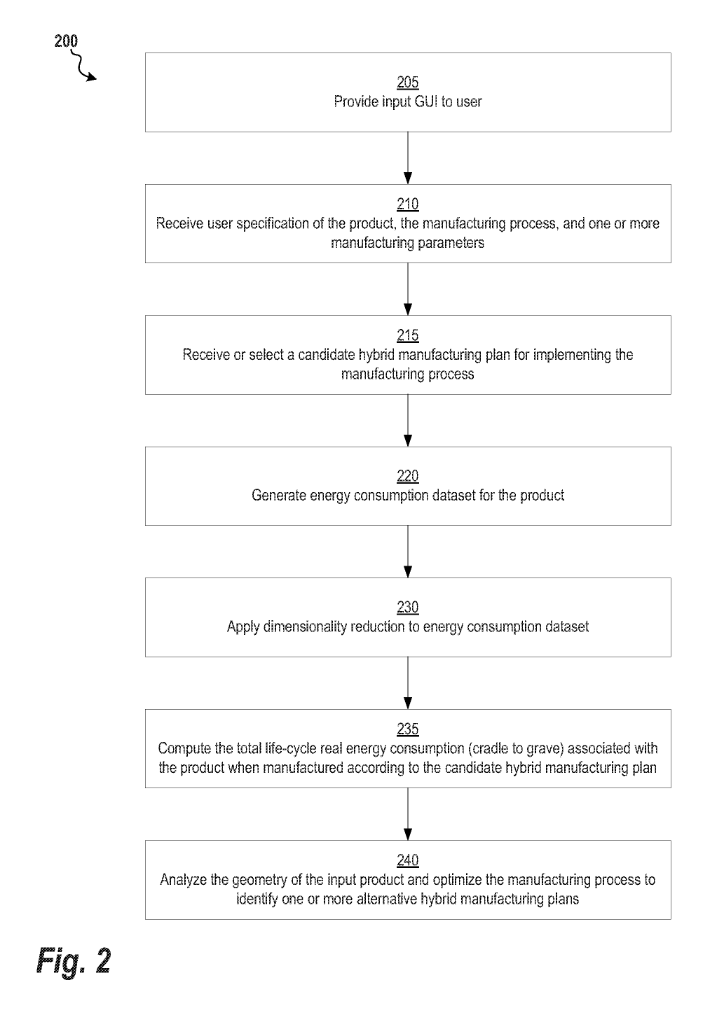

In some embodiments, the LCEA Computer 105 provides information of the overall energy required for manufacturing that can be reduced by changing the underlying geometry. For example, if a product has through-hole features, it is most energy and resource efficient if the user utilizes additive manufacturing to produce the part without the holes and adds the holes later using drilling operations. In some embodiments, the LCEA Computer 105 may consider the uncertainty of the system parameters such as material properties and they will be efficiently quantified, propagated, and managed to make accurate predictions for the suggested manufacturing process. The operation of the LCEA Computer 105 is described in further detail below with reference to FIG. 2.

Rather than having a dedicated LCEA Computer 105, in some embodiments, an LCEA software tool may be implemented using the functionality discussed above. Such software may be implemented as a standalone product or combined with a computer-aided manufacturing (CAM) and computer aided process planning (CAPP) computing platform such as Siemens Teamcenter.

FIG. 2 provides a flow chart 200 illustrating a computer-implemented method for optimizing manufacturing of a product based on total life cycle energy consumption, according to some embodiments. This method may be implemented, for example, by the LCEA Computer 105 shown in FIG. 1. Starting at step 205, a graphical user interface (GUI) is presented to a user allowing the user to input various details about the manufacturing process. Using this interface, at step 210 the user specifies the product, the manufacturing process, and one or more manufacturing parameters. These manufacturing parameters may include information such as, the raw material type associated with the product, the total number of products that will be manufactured over a certain time period, and/or an estimate of the average transportation distance between facilities that will be manufacturing the product. It should be noted that, as an alternative to user input, some of this information may be automatically determined. For example, based on a user identification of a product, a default manufacturing process and default manufacturing parameters may be selected. In some embodiments, the user may have an opportunity to modify these default values through the graphical user interface.

At step 215, a candidate hybrid manufacturing plan for implementing the manufacturing process is either received from the user (e.g., through the graphical user interface) or selected based on characteristics of the product or the manufacturing process. The plan provides details for implemented the process including, for example, the materials and machines required at each stage of the manufacturing process. The candidate manufacturing plan is a “hybrid” in the sense that it combines additive manufacture techniques with non-additive manufacture techniques. The relative proportion of the two types of techniques within the overall plan may vary. For example, the candidate hybrid plan may use 90% non-additive techniques and 10% additive techniques. As will be further described below, the variations of additive and non-additive techniques will be analyzed to evaluate the energy consumption with each manufacturing plan.

Continuing with reference to FIG. 2, at step 220, an energy consumption dataset for the product is generated using data stored in an energy consumption database. As explained above with reference to FIG. 1, this database comprises energy consumption data associated with additive and non-additive manufacturing processes, as well as energy intensity data associated with various manufacturing materials. Additionally, the database includes energy consumption data associated with other activities that occur during the product's lifecycle (e.g., shipping, end of life, etc.). In some embodiments, the database is indexed in a manner that allows quick retrieval of relevant data based on an identifier associated with the product. In other embodiments, a database management system may be used to search the database during the method in order to cull relevant data.

A dimensionality reduction process is optionally performed at step 230 on the manufacture parameters to disregard parameters that have minimal impact on energy consumption and, thus, do not need to be considered in optimizing the manufacturing plan. For example, in some embodiment, the manufacturing parameters comprise a plurality of baseline parameters and a probability for each of the plurality of baseline parameters. Then, an analysis process may be performed for each respective baseline parameter by selecting a range of parameter values for the respective baseline parameter based on its corresponding probability distribution and segmenting the range of parameter values into parameter subsets based on a pre-determined granularity for the respective parameter. In multiple instances, a simulation may be run with the performance requirements to yield snapshots which, in turn, may be used to derive a reduced order model (e.g., a Proper Orthogonal Decomposition basis). Then, a sensitivity analysis may be performed on the reduced order model to determine how sensitive the system is to the particular manufacturing parameter. Once this is completed for all manufacturing parameters, the parameters may be ranked according to their respective sensitivities and the lowest ranked parameters may be disregarded from further analysis.

The information in the database is used at step 235 to compute the total life-cycle energy consumption associated with the product when manufactured according to the candidate hybrid manufacturing plan. The total life-cycle consumption includes the sum total of all energy that is consumed by the manufacture of a product, thorough its end of life. Thus, it may include information such as manufacturing energy consumption, freight and distribution energy consumption, energy consumption during use-phase of the product, and end of life energy consumption. Additionally, in some embodiments, energy intensities associated with production materials may also be included.

The manufacturing process is optimized at step 240 according to the manufacturing parameters and the energy consumption dataset to identify one or more alternative hybrid manufacturing plans which result in lower total life-cycle energy consumption in comparison to the total life-cycle energy consumption associated with the candidate hybrid manufacture plan. Each alternative hybrid manufacturing plan identified at step 240 uses a distinct alternative combination of additive manufacture techniques and non-additive manufacture techniques.

In addition to providing variation based on the type of manufacturing process used, the alternative hybrid manufacturing plans vary according to product design. For example in one embodiment, a computer aided design (CAD) model comprising geometric information associated with the product is analyzed to identify alternate product geometries which reduce the total life-cycle energy consumption in comparison to the total life-cycle energy consumption associated with the candidate hybrid manufacture plan.

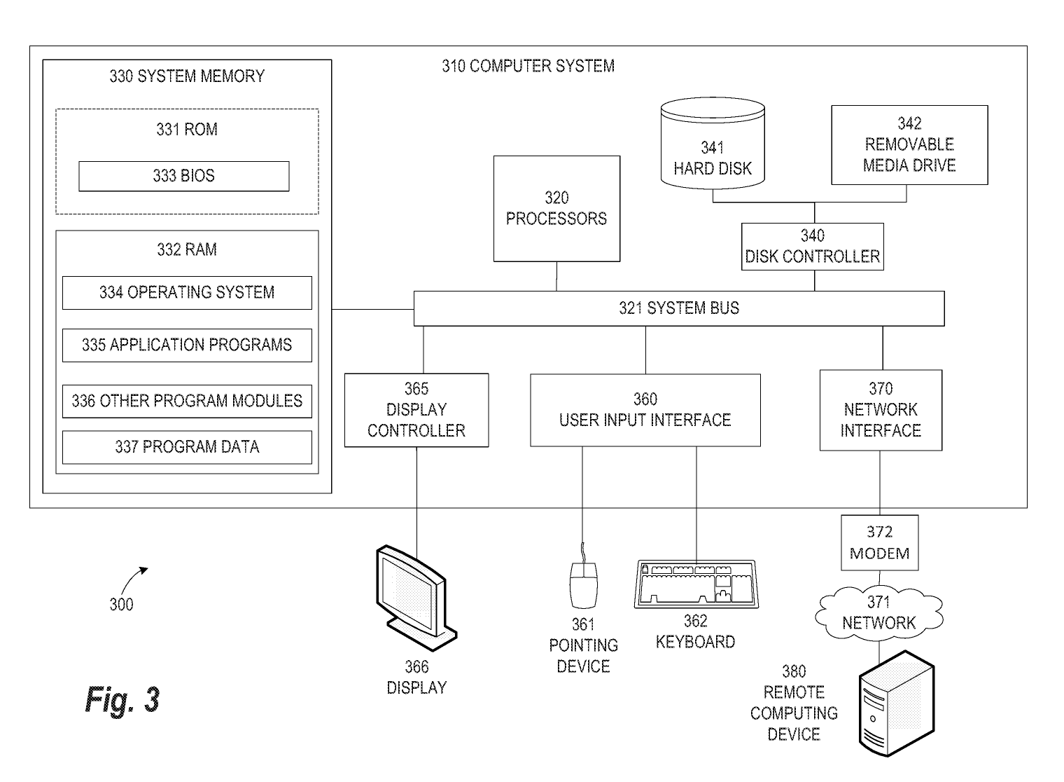

FIG. 3 illustrates an exemplary computing environment 300 within which embodiments of the invention may be implemented. In some embodiments, the computing environment 300 may be used to implement one or more of the components illustrated in the system 100 of FIG. 1. For example, this computing environment 300 may be configured to execute the control and optimization process 200 described above with respect to FIG. 2. Computers and computing environments, such as computer system 310 and computing environment 300, are known to those of skill in the art and thus are described briefly here.

As shown in FIG. 3, the computer system 310 may include a communication mechanism such as a bus 321 or other communication mechanism for communicating information within the computer system 310. The computer system 310 further includes one or more processors 320 coupled with the bus 321 for processing the information. The processors 320 may include one or more central processing units (CPUs), graphical processing units (GPUs), or any other processor known in the art.

The computer system 310 also includes a system memory 330 coupled to the bus 321 for storing information and instructions to be executed by processors 320. The system memory 330 may include computer readable storage media in the form of volatile and/or nonvolatile memory, such as read only memory (ROM) 331 and/or random access memory (RAM) 332. The system memory RAM 332 may include other dynamic storage device(s) (e.g., dynamic RAM, static RAM, and synchronous DRAM). The system memory ROM 331 may include other static storage device(s) (e.g., programmable ROM, erasable PROM, and electrically erasable PROM). In addition, the system memory 330 may be used for storing temporary variables or other intermediate information during the execution of instructions by the processors 320. A basic input/output system (BIOS) 333 containing the basic routines that helps to transfer information between elements within computer system 310, such as during start-up, may be stored in ROM 331. RAM 332 may contain data and/or program modules that are immediately accessible to and/or presently being operated on by the processors 320. System memory 330 may additionally include, for example, operating system 334, application programs 335, other program modules 336 and program data 337.

The computer system 310 also includes a disk controller 340 coupled to the bus 321 to control one or more storage devices for storing information and instructions, such as a hard disk 341 and a removable media drive 342 (e.g., floppy disk drive, compact disc drive, tape drive, and/or solid state drive). The storage devices may be added to the computer system 310 using an appropriate device interface (e.g., a small computer system interface (SCSI), integrated device electronics (IDE), Universal Serial Bus (USB), or FireWire).

The computer system 310 may also include a display controller 365 coupled to the bus 321 to control a display 366, such as a cathode ray tube (CRT) or liquid crystal display (LCD), for displaying information to a computer user. The computer system includes an input interface 360 and one or more input devices, such as a keyboard 362 and a pointing device 361, for interacting with a computer user and providing information to the processor 320. The pointing device 361, for example, may be a mouse, a trackball, or a pointing stick for communicating direction information and command selections to the processor 320 and for controlling cursor movement on the display 366. The display 366 may provide a touch screen interface which allows input to supplement or replace the communication of direction information and command selections by the pointing device 361.

The computer system 310 may perform a portion or all of the processing steps of embodiments of the invention in response to the processors 320 executing one or more sequences of one or more instructions contained in a memory, such as the system memory 330. Such instructions may be read into the system memory 330 from another computer readable medium, such as a hard disk 341 or a removable media drive 342. The hard disk 341 may contain one or more datastores and data files used by embodiments of the present invention. Datastore contents and data files may be encrypted to improve security. The processors 320 may also be employed in a multi-processing arrangement to execute the one or more sequences of instructions contained in system memory 330. In alternative embodiments, hard-wired circuitry may be used in place of or in combination with software instructions. Thus, embodiments are not limited to any specific combination of hardware circuitry and software.

As stated above, the computer system 310 may include at least one computer readable medium or memory for holding instructions programmed according to embodiments of the invention and for containing data structures, tables, records, or other data described herein. The term “computer readable medium” as used herein refers to any medium that participates in providing instructions to the processor 320 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 341 or removable media drive 342. Non-limiting examples of volatile media include dynamic memory, such as system memory 330. Non-limiting examples of transmission media include coaxial cables, copper wire, and fiber optics, including the wires that make up the bus 321. Transmission media may also take the form of acoustic or light waves, such as those generated during radio wave and infrared data communications.

The computing environment 300 may further include the computer system 310 operating in a networked environment using logical connections to one or more remote computers, such as remote computer 380. Remote computer 380 may be a personal computer (laptop or desktop), a mobile device, a server, a router, a network PC, a peer device or other common network node, and typically includes many or all of the elements described above relative to computer system 310. When used in a networking environment, computer system 310 may include modem 372 for establishing communications over a network 371, such as the Internet. Modem 372 may be connected to bus 321 via user network interface 370, or via another appropriate mechanism.

Network 371 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 310 and other computers (e.g., remote computer 380). The network 371 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 371.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for optimizing manufacturing of a product based on total life cycle energy consumption, the method comprising:
receiving, by a computer, a plurality of manufacturing parameters associated with manufacturing the product according to a manufacturing process;
receiving, by the computer, a candidate hybrid manufacturing plan for implementing the manufacturing process using a first combination of additive manufacture techniques and non-additive manufacture techniques;
generating, by the computer, an energy consumption dataset comprising (i) first energy consumption data corresponding to a non-additive manufacturing process, (ii) second energy consumption data corresponding to an additive manufacturing process, and (iii) energy intensity data associated with a plurality of manufacturing materials;
computing, by the computer, total life-cycle energy consumption associated with the product when manufactured according to the candidate hybrid manufacturing plan; and
optimizing, by the computer, the manufacturing process according to the manufacturing parameters and the energy consumption dataset to identify one or more alternative hybrid manufacturing plans which result in lower total life-cycle energy consumption in comparison to the total life-cycle energy consumption associated with the candidate hybrid manufacture plan, wherein each alternative hybrid manufacturing plan uses a distinct alternative combination of additive manufacture techniques and non-additive manufacture techniques.

2. The method of claim 1, wherein the manufacturing parameters comprise an indication of raw material type associated with the product.

3. The method of claim 1, wherein the manufacturing parameters comprise an indication of a number of products that will be manufactured.

4. The method of claim 1, wherein the manufacturing parameters comprise an indication of average transportation distance between facilities implementing the candidate hybrid manufacturing plan.

5. The method of claim 1, wherein optimization of the manufacturing process comprises:
receiving an computer aided design (CAD) model comprising geometric information associated with the product;
analyzing the CAD model to identify one or more alternate product geometries which reduce the total life-cycle energy consumption in comparison to the total life-cycle energy consumption associated with the candidate hybrid manufacture plan,
wherein at least one of the alternative hybrid manufacturing plans corresponds to one of the alternate product geometries.

6. The method of claim 1, wherein a dimensionality reduction process is applied to the manufacturing parameters to disregard one or more of the manufacturing parameters prior to optimizing the manufacturing process.

7. The method of claim 6, wherein the manufacturing parameters comprise a plurality of baseline parameters and a probability for each of the plurality of baseline parameters and the dimensionality reduction process comprises:
receiving, by the computer, one or more performance requirements;
for each respective baseline parameter included in the plurality of baseline parameters, using the computer to perform an analysis process comprising:
selecting a range of parameter values for the respective baseline parameter based on its corresponding probability distribution,
segmenting the range of parameter values into a plurality of parameter subsets based a pre-determined granularity for the respective parameter,
running a plurality of instances of a simulation using the one or more performance requirements to yield a plurality of snapshots, wherein each respective instance corresponds to one of the plurality of parameter subsets,
deriving a reduced order model using the plurality of snapshots,
performing a sensitivity analysis based on the reduced order model to yield a sensitivity measurement representative of an effect of variation of the respective parameter on the one or more performance requirements; and
generating, by the computer, a ranking of the plurality of baseline parameters according to their corresponding sensitivity measurements; and
removing, by the computer, a predetermined number of lowest ranking baseline parameters from the manufacturing parameters.

8. The method of claim 7, wherein the reduced order model comprises a Proper Orthogonal Decomposition (POD) basis.

9. The method of claim 1, further comprising:
using an evidence theory-based uncertainty propagation technique during optimization of the manufacturing process to identify the one or more alternative hybrid manufacturing plans.

10. The method of claim 1, wherein the total life-cycle energy consumption associated with each of the alternative hybrid manufacture plans comprises (i) a measure of manufacturing energy consumption, (ii) a measure of freight and distribution energy consumption, (iii) a measure of energy consumption during use-phase of the product, and (iv) a measure of end of life energy consumption.

11. A computer-implemented method for optimizing manufacturing of a product based on total life cycle energy consumption, the method comprising:
receiving, by the computer, a manufacturing process comprising a plurality of steps;
generating, by the computer, an energy consumption dataset comprising (i) first energy consumption data corresponding to a non-additive manufacturing process, (ii) second energy consumption data corresponding to an additive manufacturing process, and (iii) energy intensity data associated with a plurality of manufacturing materials;
using the energy consumption dataset to identify an optimal hybrid manufacturing plan which implements the plurality of steps using a combination of additive manufacture techniques and non-additive manufacture techniques and minimizes total product life-cycle energy consumption.

12. The method of claim 11, wherein the total product life-cycle energy consumption is a summation of a plurality of energy consumption measures comprising (i) a measure of manufacturing energy consumption, (ii) a measure of freight and distribution energy consumption, (iii) a measure of energy consumption during use-phase of the product, and (iv) a measure of end of life energy consumption.

13. The method of claim 12, further comprising:
providing a visual representation of each of the energy consumption measures in a graphical user interface for display to a user.

14. The method of claim 11, further comprising:
using the energy consumption dataset to identify an alternative hybrid manufacturing plans which implement the manufacturing process using an alternative combination of additive manufacture techniques and non-additive manufacture techniques;
identifying an alternative total product life-cycle energy consumption corresponding to the alternative hybrid manufacturing plan; and
presenting differences between the total product life-cycle energy consumption associated with the optimal hybrid manufacturing plan and the alternative total product life-cycle energy consumption in a graphical user interface for display to a user.

15. The method of claim 14, further comprising:
determining a first uncertainty quantification measurement associated with the optimal hybrid manufacturing plan;
determining a second uncertainty quantification measurement associated with the alternative hybrid manufacturing plan; and
presenting the first uncertainty quantification measurement and the second uncertainty quantification measurement in the graphical user interface for display to the user.

16. The method of claim 14, wherein the method further comprises:
receiving an computer aided design (CAD) model comprising geometric information associated with the product;
analyzing the CAD model to identify one or more alternate product geometries which minimize life-cycle energy consumption,
wherein at least one of the alternative hybrid manufacturing plan corresponds to one of the alternate product geometries.

17. The method of claim 11, further comprising:
prior to identifying the optimal hybrid manufacturing plan, applying a dimensionality reduction process to the energy consumption dataset to disregard energy consumption data items having minimal impact to the total product life-cycle energy consumption.

18. The method of claim 17, wherein the energy consumption data items having minimal impact to the total product life-cycle energy consumption are identified by a process comprising:
determining a sensitivity measurement for each energy consumption data item included in the energy consumption dataset;
ranking each energy consumption data item included in the energy consumption dataset according to its corresponding sensitivity measurement;
designating a predetermined number of lowest ranking energy consumption data item as the energy consumption data items having minimal impact to the total product life-cycle energy consumption.

19. A system for optimizing manufacturing of a product based on the product's total life cycle energy consumption, the system comprising:
a user interface configured to receive (i) an indication of the product, (ii) a plurality of manufacturing parameters associated with manufacturing the product according to a manufacturing process, and (iii) a candidate hybrid manufacturing plan for implementing the manufacturing process using a first combination of additive manufacture techniques and non-additive manufacture techniques;
non-volatile memory comprising a database storing (i) first energy consumption data corresponding to non-additive manufacturing processes, (ii) second energy consumption data corresponding to additive manufacturing processes, and (iii) energy intensity data associated with a plurality of manufacturing materials;
a computer configured to:
compute total life-cycle energy consumption associated with the product when manufactured according to the candidate hybrid manufacturing plan; and
optimize the manufacturing process according to the manufacturing parameters and data in the database to identify one or more alternative hybrid manufacturing plans which result in lower total life-cycle energy consumption in comparison to the total life-cycle energy consumption associated with the candidate hybrid manufacture plan, wherein each alternative hybrid manufacturing plan uses a distinct alternative combination of additive manufacture techniques and non-additive manufacture techniques.

20. The system of claim 19, further comprising:
a manufacturer interface configured to:
use one or more application program interfaces energy consumption data to receive from one or more manufacturing materials producers;
structure the energy consumption data in a standard data format; and
store the energy consumption data the database.
